(19) United States
(12) Patent Application Publication
(10) Pub. No.: US 2016/0060447 A1
(43) Pub. Date: Mar. 3, 2016

(54) Hair Weave Thread that is Conveniently Removable via Solvent-Catalyzed Stress Cracking

(71) Applicants: James Zwynenburg, Queensbury, NY (US); Roger W. Faulkner, Concord, NC (US); Adan Jalil, Laguna Hills, CA (US); James Christopher Jones, Eastvale, CA (US)

(72) Inventors: James Zwynenburg, Queensbury, NY (US); Roger W. Faulkner, Concord, NC (US); Adan Jalil, Laguna Hills, CA (US); James Christopher Jones, Eastvale, CA (US)

(21) Appl. No.: 14/474,350

(22) Filed: Sep. 2, 2014

(51) Int. Cl. C08L 27/06; C08K 5/13; C08K 5/1515; C08K 5/10; C08K 5/42; C08K 5/11; C08K 5/12

(52) U.S. Cl. CPC C08L 27/06; C08K 5/11; C08K 5/13; C08K 5/12; C08K 5/10; C08K 5/42; C08K 5/1515

(57) ABSTRACT

This disclosure concerns improved polymeric thread for use in hair braiding. The novel threads used for this purpose are polymers that are stretched more than 10% during application as hair weave threads. Removal of the stretched threads is easily accomplished by applying a few drops of removal solvent or solution such as acetone to the extended thread, which breaks into short pieces that can easily be removed from hair with a brush, comb or by shampooing. This is highly advantageous compared to prior art hair weave threads, which must typically be cut to remove them from the hair, which both slows the removal process and introduces collateral hair damage, as some hairs are also accidentally cut when the prior art non-elastomeric hair weave threads are cut to remove them from the hair. The breaking of the extended threads is also much faster than the time required to dissolve the threads, and represents a new mechanism entirely for removing weave threads from hair.

### BACKGROUND OF THE INVENTION

Soluble polymeric threads can be used in creating a removable hair weave. These threads could be soluble in water (such as Vanish™ thread from Superior Threads), but then it is not possible to wash one's hair without dissolving the threads, and both rain and sweat may cause the threads to dissolve, all of which is not desirable. Hair styling adhesives are known which are soluble in organic solvents (see for example US patent application 2008/0219941) and some such polymers could also be used for dissolvable polymeric hair weave threads, but removal of such threads would require a fairly long exposure of the hair and scalp to solvents, which is both dangerous in terms of flammability and risky in terms of solvent exposure for both the customer and the cosmetologist.

Hair weaving threads that are soluble in water with added acid (vinegar for example) or base (ammonia for example), but not in pure water are feasible, but then again both the customer and cosmetologist are exposed for a period of minutes to smelly and disagreeable water solutions. Complete removal of any thread from the hair via dissolving the thread in a solvent is also quite difficult, as there is a need for adequate exposure time to the solvent to create a polymer solution, and after that, more time is needed for thorough rinsing to remove the last traces of any soluble thread. Such rinsing will in many cases strip the natural oils from the hair and scalp. When any thread is dissolved to remove it, there is bound to be some polymer residue left behind on the hair, which is usually undesirable.

Prior art thread materials currently in commercial use as hair weave threads include polyester, polyamide, and natural polymers like cotton, silk, or animal hair (like wool or horse hair). These thread materials are not elastomeric, and stretch less than 10% during application to the hair Such prior art threads must be removed using scissors to cut out the weave. During this process some hair is usually cut and removed; this collateral damage can be highly undesirable, depending on hair style.

Rheology is the branch of physics that studies the flow of matter. Simple chemical compounds like air and water, which are either gas or liquid at normal ambient temperatures exhibit flow and are classified as fluids. An important distinguishing property of fluids is known as viscosity, which is a measurement of the resistance to flow. Fluids are thus considered to have “viscous” properties. Other simple chemical compounds like steel at normal ambient temperatures are classified as elastic. The term “elastic” refers to the capability to return to original shape after application of stretching or compressive forces. Elastic materials are generally characterized in terms of tensile modulus, shear modulus, and Poisson's ratio, as the flow (viscous) component of deformation is neglected below a threshold strain, the elastic limit.

Polymeric materials are considered to have “viscoelastic” characteristics, which means that they simultaneously exhibit both viscous and elastic properties. The viscous and elastic properties of polymeric materials change behavior over a broad range of temperatures. The particular viscoelastic behavior of a polymeric material depends upon its molecular structure and thus, a certain range of rheological values can be used to characterize the behavior of a particular polymeric material. Depending upon the measurement technique, the storage modulus is referred to as E′ (tensile modulus) or G′ (shear modulus), while the loss moduli is referred to as E″ or G″. Unlike the simpler chemical compounds, polymeric materials have a complex rheological behavior.

Standardized terminology and test methods have been developed by organizations respected worldwide, such as ASTM International, or the International Standards Organization (ISO) to quantify the dynamic behavior of various materials. ASTM D4092-01, “Standard Terminology: Plastics: Dynamic Mechanical Properties”, by ASTM International provides the broadest compilation of the generally accepted definitions and the descriptions of technical terms associated with measurement of dynamic mechanical properties of polymeric materials. The ASTM International definitions for the terms utilized in describing the materials of this invention is incorporated herein by reference.

### Dynamic Mechanical Analysis (Melt Phase)

ASTM D4440-01, “Standard Test Method for Plastics: Dynamic Mechanical Properties: Melt Rheology”, by ASTM International, and ISO 6721 Part 10, “Plastics-Determination of Dynamical Properties, Part 10, Complex Shear Viscosity Using a Parallel Plate Oscillatory Rheometer” by the International Standards Organization detail generally acceptable methods for utilization of dynamic mechanical instrumentation in reporting rheological properties of thermoplastic polymeric materials at various conditions of frequency, strain amplitude, and temperature. These test methods, incorporated herein by reference, have been utilized to characterize the materials of this invention.

Dynamical Mechanical Spectroscopy is the term generally used to describe dynamic mechanical testing of materials over a range of temperatures and/or frequency. The standardized tests specify testing with two parallel plates with equal diameters but allows variable plate diameters and gaps between those plates in the reported testing configuration. Two important rheological values provided by the standardized dynamic mechanical testing of molten polymers are the loss tangent, identified by the expression tan 8, and the complex viscosity, identified with the symbol η*.

Although the loss tangent (tan δ) and the complex viscosity (η*) are normally adequate to describe the rheological behavior of polymers for many applications, the ability of a polymeric material to produce a monofilament in a conventional filament extrusion process is not sufficiently described by those rheological terms at only one particular temperature. For example, two materials which have equivalent tan δ and η* at a particular temperature can have very different results in an extrusion process. Consequently, characterization of a polymeric material that can produce polymeric filament requires at least one additional value, the change of tan δ and/or η* versus temperature.

### Dynamic Mechanical Analysis (Solid Phase)

ASTM D4065-01, “Standard Test Method for Plastics: Plastics: Dynamic Mechanical Properties: Determination and Report of Procedures”, by ASTM International, and ISO ISO 6721, Part 1 Plastics—Determination of Dynamic Mechanical Properties, Part 1, General Principles” by the International Standards Organization detail generally acceptable methods for utilization of dynamic mechanical instrumentation in reporting rheological properties of thermoplastic polymeric materials at various conditions of frequency, strain amplitude, and temperature. These test methods, incorporated herein by reference, have been utilized to characterize the materials of this invention.

### SUMMARY OF THE INVENTION

The invention uses stress cracking of non-crystalline or low crystallinity polymeric threads in the presence of a removal solution to cause the stretched threads to break up into short pieces. A variety of polymers can be used in the invention, including both stiff and elastomeric polymer formulations; the process we are using is essentially solvent or surfactant-assisted stress cracking, and since this patent application is the first to describe use of stress cracking to remove hair braids, any combination of polymeric thread and a liquid removal solution that causes cracking and rupture of extended threads within one minute is an example of the invention. We have shown that polycarbonate or ABS threads which are stressed to 50% of their breaking stress undergo stress cracking and rupture when exposed to acetone in their extended and stressed state within one minute.

A particularly useful set of polymers for the invention are the elastomers, particularly thermoplastic elastomers. As used herein, thermoplastic elastomers are meltable polymer formulations that can be stretched at least 100% before rupturing, and which return to within 10% of their original length within ten seconds after being deformed 100% and held at 100% strain for a minute before being released. This definition of thermoplastic elastomer is broad enough so it applies to plasticized polyvinyl chloride (PVC), elastomeric thermoplastic urethanes (TPUs), multiblock polyester elastomers (such as Hytrel), triblock thermoplastic elastomers (such as Kraton), or thermoplastic vulcanizates (TPVs such as Santoprene). Thermoplastic elastomers as a group have the advantage for hair weave threads that they are significantly extended in the as-used state, and so tend to maintain a grip on the hair even if there is some movement that could potentially loosen hair weave threads that were not extended as much.

A particularly desirable type of hair weave threads is made of PVC plastisols containing 20-50% by weight plasticizer in PVC and/or PVC copolymers; the preferred range of plasticizer is 30-40% by weight. The formulations of greatest interest have a stress at 50% strain between four and eight MPa, the ability to retain stress for a period of months at normal human body temperature, and a removal solution or mixture that works in less than one minute to cause the stretched threads to fail. Acetone has been found to work as a removal solution for all polymer systems tested so far, including PVC, PVC copolymers, polycarbonate, and ABS; other solvents and solvent blends are described herein below.

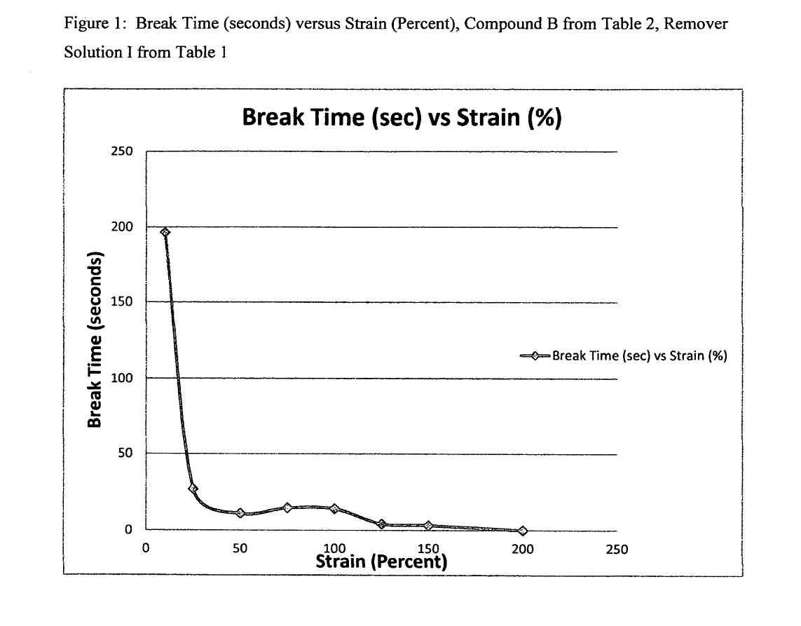

FIG. 1 shows data on breakage time versus strain for Compound B in Table 2 from an extended hair weave thread of this invention. In this experiment, whole threads were used for both the tensile test and break time test performed on the weave threads. The solution used to break the thread was Weave Remover Solution D from Table 1. In the break time test, the specimens were tested using a Shimadzu AGS-X universal test machine equipped with 1.5×2 inch rubber faces jaws and a 100-Newton load cell. The initial gauge length was set to 50 mm, and the universal tester was set to stretch the 50 mm gauge length thread to the stains shown in Table 1 at a rate of 500 mm/minute (for example, the 50 mm thread was stretched to 75 mm to give 50% extension). While in tension, the thread was exposed to the Weave Remover Solution D, and the time needed for the thread to break after exposure was recorded. The average of three or more breakage events at each strain were used in plotting FIG. 1.

For the PVC plastisol threads, the threads must be able to be extended more than 100% prior to rupture in standard mechanical tests, and more preferably should be able to be extended more than 200% prior to rupture in standard mechanical tests. Most preferably, the threads should be able to extend 150% without rupture and remain in that strained condition for several months until touching the removal solution, after which they fail rapidly. When the threads are installed into the hair, they are stretched, and remain under tension during use. The mechanism of cracking is similar to what is commonly called “environmental stress cracking” in the polymer literature. The best examples we have found so far are plasticized PVC polymer- and/or copolymer-based threads, but we believe this method is applicable to numerous other elastomeric polymeric systems which can produce an extensible thread that retains some of its stress for at least several months when used as hair thread.

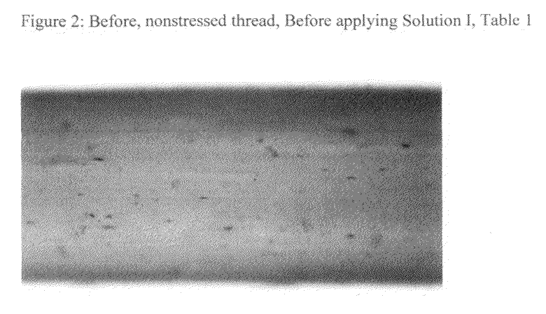

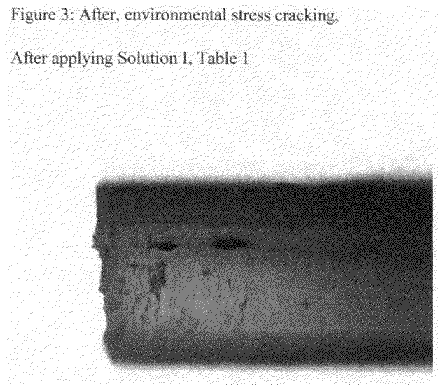

We do not wish to be bound by any particular theory for the way the process works, but in general, we think that the plasticizer in the thread increases permeability to the removal solution and therefore speeds rupture. At the same time, increasing levels of plasticizer reduce both stiffness and strength, while increasing elongation to break. Within a specific type of polymer, the optimum amount of plasticizer increases with molecular weight of the polymer. There are a wide variety of polymers that can be used, including various polymer blends and thermoplastic elastomers as well as swollen partially crystalline polymers like plasticized PVC. FIG. 2 shows a sample thread before applying Solution I in Table 1 to Compound in Table 2. FIG. 3 shows the broken edge of the thread after environmental stress cracking in the area of FIG. 2, after being cracked by application of Solution I in an extended state. It is clear that numerous surface cracks have opened up, in addition to the one that caused failure.

For plasticized PVC, we claim that any plasticized polymer with plasticizer level between 20-50% of the total system weight, elongation to break greater than 100%, and stress at 50% elongation between 4-12 MPa is an embodiment of the invention if acetone dripped onto the stretched threads at 50% elongation causes the stretched thread to rupture in less than one minute. A more preferred range of the compositions and properties for plasticized PVC hair weave threads is that plasticizer content is 30-40%, minimum elongation to break is 200%, with 300% preferred, the threads are around 0.75 mm in diameter, stress at 50% elongation is 5-7 MPa, the strength is greater than 16 MPa, and rupture occurs within 10 seconds for threads stetched 150% when exposed to either acetone or butylene carbonate.

Although the examples we have so far involve solvents like ketones (acetone, MEK, MIBK); esters like butyl acetate or isopentyl acetate; or cyclic carbonates like ethylene, propylene, and/or butylene carbonate to cause the thread to rupture, we also anticipate certain other solvents to be especially promising such as methylol and ethylol, based on the wide use of these potent solvents in perfume and personal care products, and the fact that they are exempt from various air pollution regulations due to their low potential for smog formation. We also expect that various surfactants (in anhydrous form) will cause the thread to rupture, though more slowly. These surfactants may well be non-volatile, and safer to use in the hair removal process. We anticipate that surfactants will require longer exposure time to cause the cracking to occur.

The thread also has essential oils that fortify the hair and promote healthy hair. Argan oil penetrates the hair follicle pores and is able to promote hair elasticity, thus nourishing the hair. Other essential oils include coconut and monoi.

### DETAILED DESCRIPTION OF THE INVENTION

The thread contains 0.1 to 8.0 weight percent essential oils that fortify the hair and promote healthy hair. Coconut, Argan, and Monoi are the main oils used in the thread production. The more preferred loading of the essential oils is in the range of 0.2 to 4 weight percent. The most preferred loading of the essential oils (mixture of the three) is in the range of 1.0 to 2.5 weight percent.

FIG. 1 shows data on breakage time versus strain for a thread of this invention, and one particular solvent mixture as the removal solution. Whole threads were used for both the tensile tests and break time tests performed on the weave threads. The solution used to break the thread was Remover Solution D from Table 1. In the break time test, the specimens were tested using a Shimadzu AGS-X universal test machine equipped with 1.5×2 inch rubber faces jaws and a 100-Newton load cell. The initial gauge length was set to 50 mm, and the universal tester extension speed was 500 mm/minute to stretch the 50 mm clamped length to whatever gage length is needed to obtain the desired strain that is being tested (these conditions were used for FIG. 1 and for all other break time tests cited in this document). While in tension, the thread, which was Compound B from Table 2, was exposed to Remover Solution D from Table 1, and the time needed for the thread to break after exposure was recorded.

TABLE 1
Remover Solutions Tests

| Remover Solutions | A | B | C | D | E | F | G | H | I | J |
|---|---|---|---|---|---|---|---|---|---|---|
| Acetone | 100 | 85 | 0 | 10 | 0 | 0 | 0 | 0 | 0 | 0 |
| MEK | 0 | 0 | 0 | 0 | 0 | 0 | 100 | 0 | 0 | 0 |
| Butyl Acetate | 0 | 0 | 0 | 9 | 0 | 100 | 0 | 0 | 36 | 0 |
| Water | 0 | 15 | 0 | 0 | 0 | 0 | 0 | 0 | 0 | 0 |
| Ethylene Carbonate | 0 | 0 | 0 | 0 | 0 | 0 | 0 | 50 | 28 | 0 |
| Propylene Carbonate | 0 | 0 | 0 | 20 | 100 | 0 | 0 | 50 | 28 | 0 |
| Butylene Carbonate | 0 | 0 | 100 | 60 | 0 | 0 | 0 | 0 | 0 | 0 |
| Methyl Isobutyl Ketone | 0 | 0 | 0 | 0 | 0 | 0 | 0 | 0 | 3 | 0 |
| Iso-Amyl Acetate | 0 | 0 | 0 | 0 | 0 | 0 | 0 | 0 | 3 | 0 |
| Butanol | 0 | 0 | 0 | 0 | 0 | 0 | 0 | 0 | 0 | 100 |
| Lemongrass Oil | 0 | 0 | 0 | 1 | 0 | 0 | 0 | 0 | 0 | 0 |
| Coconut Oil | 0 | 0 | 0 | 0 | 0 | 0 | 0 | 0 | 2 | 0 |
| Breaks <30 Seconds | yes | yes | yes | yes | no | yes | yes | no | yes | no |

The solvents that worked for the (150814 thread) Compound B Table 2 (0.73 mm diameter). 150% strain
Ketones: Acetone, methyl isobutyl ketone, methyl isoamyl ketone
Carbonates: Butylene carbonate
Acetate: butyl acetate, amyl acetate, isoamyl acetate
Solvents that failed, did not work:
Water
Water with soap (shampoo)
50% water with %50 acetone
Dimethyl succinate
Alcohols: ethanol, isopropyl alcohol, butanol, denatured alcohol

The plasticized PVC-based threads rupture fast (typically within 6 seconds) with acetone (Removal Solution A from Table 1). Adding 15% water, as in Removal Solution B, which is a 85/15 acetone/water mixture inhibits rupture of the extended thread by Removal Solution B (rupture of thread of Example 2, stretched 150%, went from 6 seconds for pure acetone to 17 seconds for Removal Solution B. An acetone/water mixture of 70/30 will take 3 minutes to break the thread, even in the few instances where it works at all. It is noteworthy that 85/15 acetone/water mix works s well as it does, because this mixture cannot dissolve PVC nor PVC/Ac copolymers.

The most effective alternative solvent to acetone, which we discovered because we were looking for a safer alternative, is butylene carbonate, Removal Solvent C of Table 1. This is a high boiling liquid that remains below its flash point at all times when used as a removal solvent, and which is modestly more effective than acetone (typical time to rupture for a stressed thread 4 seconds). Removal Solvent D of Table 1 is equally effective to acetone, with intermediate flash point between acetone and butylene carbonate, but lower surface tension than butylene carbonate; this aids its wetting into possibly oily hair that may surround the hair weave threads. The other removal solutions of Table 1 give a variety of pure materials and mixtures that work or do not work as removal solutions for plasticized PVC threads of the current invention; footnotes to Table 1 give additional information.

Another effective solvent is isoamyl acetate (banana oil), Remover Solution I in Table 1. Both the natural oil and the synthetic versions work.

Plasticized PVC-vinylacetate copolymers (PVCNA) and/or PVC-PVCNA blends containing around 5% by weight vinylacetate monomer residues are optimal for the threads of this invention because the speed of the stress cracking and rupture is faster for these polymers or blends compared to a similar plasticized PVC homopolymer. When vinylacetate level is 10%, the threads have an objectionable level of tack to hair and to itself. Increase of the plasticizer loading slows environmental stress cracking at a defined strain level (this is not surprising, since increasing plasticizer content also increases the elongation to break). Copolymers of polyvinylchloride include co-acetates, co-vinylalcohol, and co-acrylics. The polyvinylchloride-co-vinylacetate is more economical and available.

Dynamical Mechanical Spectroscopy “DMS” is the term generally used to describe dynamic mechanical testing of materials over a range of temperatures that spans from solids to liquids. Testing in tensile mode is convenient for solid samples, but tensile-based testing does not work for liquids, so one preferred sample shape for DMS is the parallel plate geometry, which can give good data over the whole viscoelastic range of interest.

Dynamic Mechanical Spectroscopy molten-phase property values refer to testing results as measured in accordance with standard test methods ASTM D4440 or ISO 6721-10: ASTM D4440-01, “Standard Test Method for Plastics: Dynamic Mechanical Properties: Melt Rheology”, by ASTM International, and ISO 6721 Part 10, “Plastics-Determination of Dynamical Properties, Part 10, Complex Shear Viscosity Using a Parallel Plate Oscillatory Rheometer” by the International Standards Organization detail generally acceptable methods for utilization of dynamic mechanical instrumentation in reporting rheological properties of thermoplastic polymeric materials at various conditions of frequency, strain amplitude, and temperature. These test methods, incorporated herein by reference, have been utilized to characterize the materials of this invention.

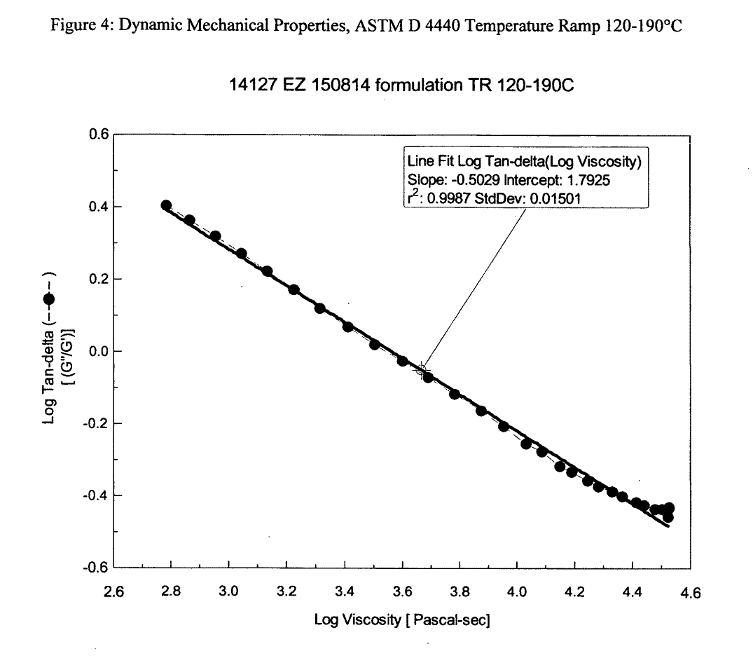

We used the parallel plate sample geometry for melt phase testing only in the temperature range of 120° C. to 190° C. FIG. 4 shows a “temperature sweep,” at a fixed frequency of 1.00 radians/sec using a 25 mm diameter parallel plates with a gap of 1.00 mm. The melt viscosity and tan-δ were measured using a Rheometric Scientific SR5 controlled stress rheometer per ASTM D 4440; the log tan-δ versus log η* data are plotted in FIG. 4, using data for Compound G from Table 2.

Testing of various copolymers of polyvinylchloride and polymeric blends that are predominantly PVC-copolymers have allowed discovery of suitable quantitative rheological relationship that characterize and predict those materials that work as hair weave threads. These relationships are described below, and have to do with the slope of the plots of logarithmic plots of damping factor (tan δ) versus complex viscosity (η*) in a temperature sweep; the slope of this plot (see FIG. 4, for example) approximates a power-law relation between the damping factor (tan δ) and the complex viscosity (η*). There is no theoretical basis for this relationship. The power-law relation that describes the loss tangent (tan δ) and the complex viscosity (η*) is determined from a log-log regression analysis of the data from the two parameters. Alternatively stated, this means the plot of log(tan δ) vs log(η*) can be approximated by a straight line, the slope (b1) of which is the exponent in the power-law relation. This approximate relationship can be summarized as:

log(tan(δ)≅b1 log(η*)+b0

In this approximating relationship, the significance of intercept (b0) is not yet understood.

The plot of log tan delta versus log viscosity has a line fit slope of −0.5029 and an intercept of 1.7925 for Compound B, Table 2, FIG. 4. The variation in slope is about 5-15% as the amount of plasticizers varies from 25 to 50%.

Dynamic Mechanical Analysis (Solid Phase): Standardized terminology and test methods have been developed by organizations respected worldwide, such as ASTM International, or the International Standards Organization (ISO) to quantify the dynamic behavior of various materials:
ASTM D4092-01, “Standard Terminology: Plastics: Dynamic Mechanical Properties”, by ASTM International provides the broadest compilation of the generally accepted definitions and the descriptions of technical terms associated with measurement of dynamic mechanical properties of polymeric materials. The ASTM International definitions for the terms utilized in describing the materials of this invention is incorporated herein by reference.
ASTM D4065-01, “Standard Test Method for Plastics: Plastics: Dynamic Mechanical Properties: Determination and Report of Procedures”, by ASTM International, and ISO
ISO 6721, Part 1 Plastics—Determination of Dynamic Mechanical Properties, Part 1, General Principles” by the International Standards Organization detail generally acceptable methods for utilization of dynamic mechanical instrumentation in reporting rheological properties of thermoplastic polymeric materials at various conditions of frequency, strain amplitude, and temperature.

These test methods, incorporated herein by reference, have been utilized to characterize the materials of this invention, as described below.

The extruded thread was thermoformed using a heated carver press, the mold was stainless steel and the inner mold was aluminum foil and a 0.55 mm spacer to control the thickness. The molding temperature was 180° C. for 2 minutes and then a force of 8-10 tones applied for 30 seconds. Samples were cut from the resulting film that were 35 mm in length, 12 mm wide and the thickness was 0.55 mm.

The dynamic mechanical analyzer was a Rheometric Scientific Solids Analyzer RSA II. The testing was a frequency sweep at 25° C. and a temperature ramp from 25° C. to 43° C. at a frequency of 6.28 radians per second. Testing geometry was a rectangular film, using a Rheometric Scientific film fixture in tensile mode.

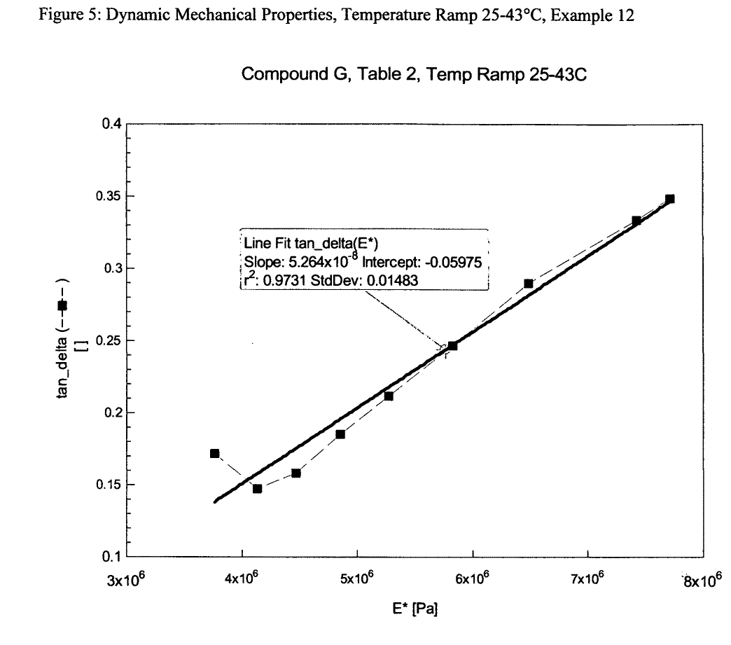

Expanding further into the temperature ramp graph from 25° C. to 43° C. we plot the tan-delta (dampening factor) versus the complex modulus E* and take the linear slope to describe the viscoelastic response versus the stiffness of the material from the typical usage temperature, FIG. 5.

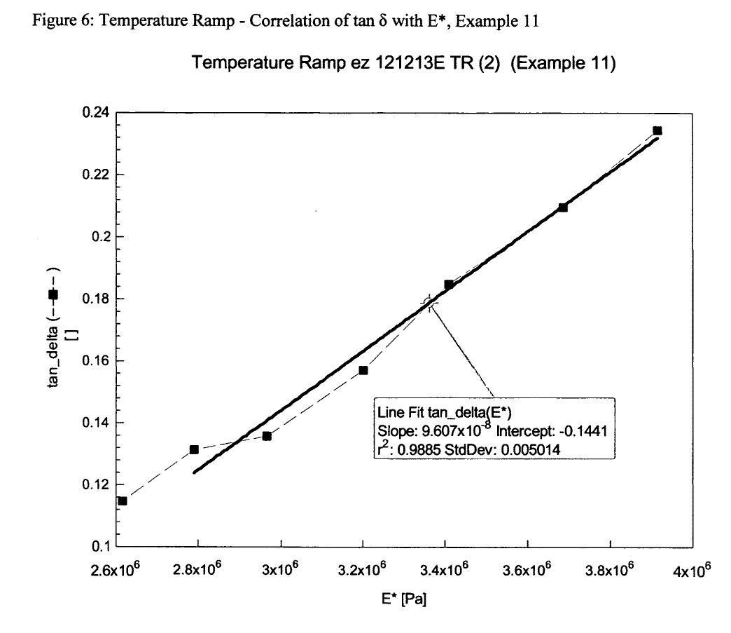

The plot of tan-delta versus the complex modulus (E*) in the temperature range of 25 C to 43 C that has 38% plasticizer, Compound G Table 2, has a slope of 5.264e-8, and Example 11, FIG. 6 had a slope of 9.507e-8, and Example 9 had a slope of 1.229e-7.

The desired thread has a slope in the range of 1e-8 to 5e-7 in the temperature range of 25-42° C. from a plot of tan-delta versus the complex modulus (E*). The more preferred slope of the plot of tan-delta versus the complex modulus (E*) is 5e-8 to 3e-7. The most preferred slope of the plot of tan-delta versus the complex modulus (E*) is 8e-8 to 2e-7.

The frequency sweep at room temperature (25° C.) measures the viscoelastic response over the frequency range of 0.1 to 100 radians per second. The material is described at the frequency of 0.1 radian per second from the tan-delta and the storage modulus (E′).

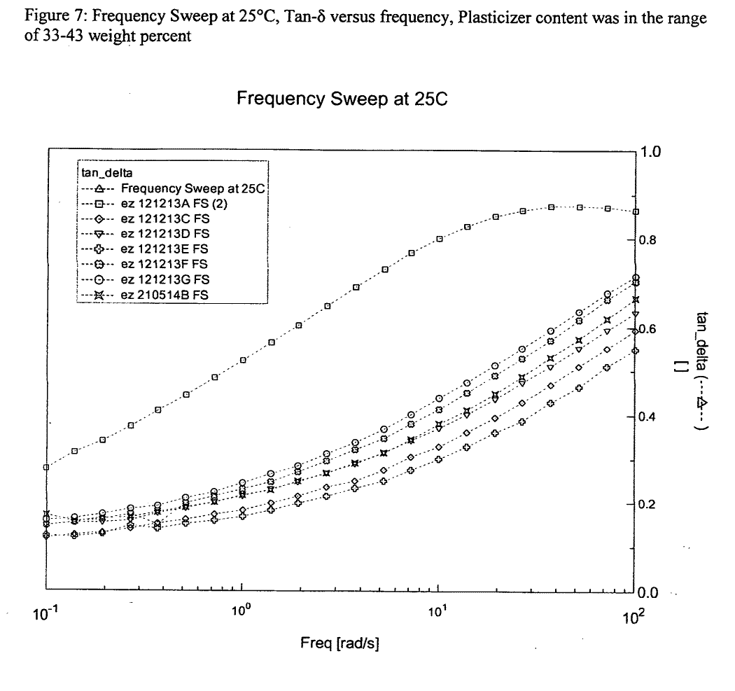

The frequency sweep at 25° C. has an overlay plot of the tan-delta versus the frequency. The tan-delta value is in the range of 0.05 to 0.5 at 0.1 radian per second. A more preferred tan-delta range is 0.07 to 0.3 at 0.1 radians per second and the most preferred tan-delta range is 0.1 to 0.3 at 0.1 radians per second, FIG. 7.

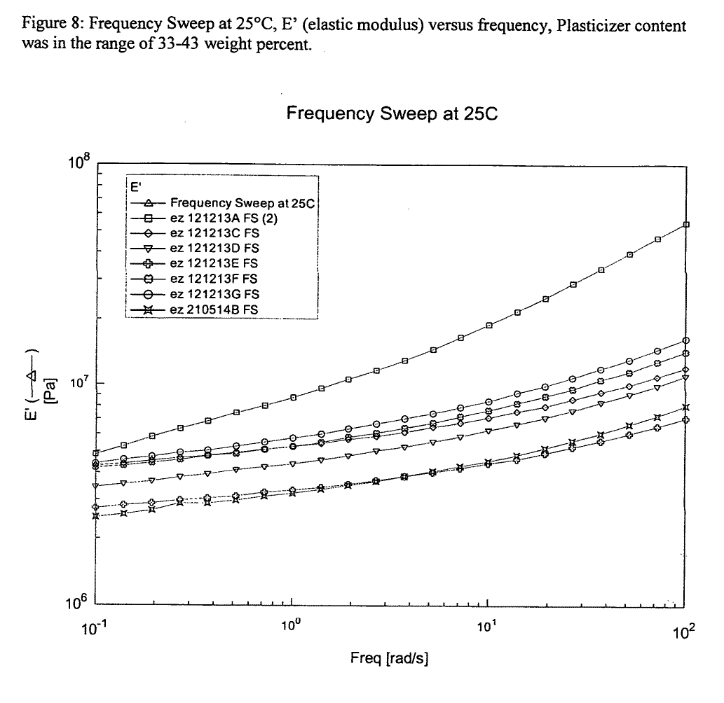

The storage modulus (E′) range at 0.1 radian per second is 1e6 to 1e7 pascals, A more preferred range is 1.5e6 to 7e6 pascals, and the most preferred range is 2e6 to 6e6 (Pascals), FIG. 8.

### EXAMPLES OF THE INVENTION

The first seven Examples are PVC-based hair weave threads that use the same plasticizers, processing aids, and fillers to compare the effects of various levels of copolymerized vinylacetate in the PVC polymer. These compounds were first mixed in a Brabender twin screw extruder in a first pass, during which a 4-5 mm thick plasticized PVC cord was produced, which was subsequently fed into the extruder for a second pass to produce hair weave thread at 0.7 mm nominal thickness.

### Example 1

We produced a plasticized PVC homopolymer thread (contains no vinylacetate), and which contains 36% by weight of liquids (plasticizers+essential oils; see Compound A of Table 2). This Compound A produced a thread that had tensile strength of 23 MPa and elongation to break of 280%. When this thread is stretched 150% and then exposed to either acetone (Removal Solution A) or Removal Solution D, it ruptures within 20 seconds of exposure to a small amount of acetone that is held against the vertical fiber by a saturated cotton ball. The same thread will also rupture within 15 seconds when exposed to a drop of butylene carbonate. This sample had suitably low surface tack so as not to stick to hair, even under high humidity conditions.

### Example 2

We produced a plasticized PVC copolymer thread with 5% of vinylacetate copolymerized monomer by polymer weight %, and containing 36% by weight of plasticizers (see Compound B of Table 2) that had tensile strength of 21 MPa and elongation to break of 310%. When this thread is stretched 150% and then exposed to either acetone (Removal Solution A) or Removal Solution D, it ruptures within 6 seconds of exposure to a small amount acetone that is held against the vertical fiber by a saturated cotton ball. The same thread will also rupture within 5 seconds when exposed to a drop of butylene carbonate. This sample had suitably low surface tack so as not to stick to hair, even under high humidity conditions.

### Example 3

We produced a plasticized PVC copolymer thread with 10% of vinylacetate copolymerized monomer by polymer weight %, and containing 36% by weight of plasticizers (see Compound C of Table 2) that had tensile strength of 18 MPa and elongation to break of 350%. When this thread is stretched 150% and then exposed to either acetone (Removal Solution A) or Removal Solution D, it ruptures within 4 seconds of exposure to a small amount acetone that is held against the vertical fiber by a saturated cotton ball. The same thread will also rupture within 4 seconds when exposed to a drop of butylene carbonate. This sample had suitably low surface tack so as not to stick to hair under low humidity conditions, but was too tacky under high humidity conditions.

### Example 4

We produced a plasticized PVC copolymer thread with 14% of vinylacetate copolymerized monomer by polymer weight %, and containing 36% by weight of plasticizers (see Compound D of Table 2) that had tensile strength of 15 MPa and elongation to break of 410%. When this thread is stretched 150% and then exposed to either acetone (Removal Solution A) or Removal Solution D, it ruptures within 3 seconds of exposure to a small amount of acetone that is held against the vertical fiber by a saturated cotton ball. This sample had too much surface tack for practical application to hair, even under low humidity conditions.

### Example 5

A 50/50 blend of PVC homopolymer and the same 10% vinylacetate PVC copolymer used in Example 3, so that the copolymerized vinylacetate content was 5% by polymer weight %, the same as Compound B and Example 2. As with all the other Examples 1-6, Example 3 contains 36% by weight of plasticizers (see Compound E of Table 2); it had tensile strength of 21 MPa and elongation to break of 300%. When this thread is stretched 150% and then exposed to either acetone (Removal Solution A) or Removal Solution D, it ruptures within 6 seconds of exposure to a small amount solution that is held against the vertical fiber by a saturated cotton ball. The same thread will also rupture within 5 seconds when exposed to a drop of butylene carbonate. This sample had suitably low surface tack so as not to stick to hair, even under high humidity conditions.

### Example 6

We produced a plasticized PVC copolymer thread with 5% of vinylacetate copolymerized monomer by polymer weight %, by blending PVC homopolymer and the same 14% vinylacetate copolymer used in Example 4. As with Examples 1-6, this compound contained 36% by weight of plasticizers (see Compound F of Table 2); it had tensile strength of 21 MPa and elongation to break of 300%. When this thread is stretched 150% and then exposed to either acetone (Removal Solution A) or Removal Solution D, it ruptures within 6 seconds of exposure to a small amount solution that is held against the vertical fiber by a saturated cotton ball. This sample had suitably low surface tack so as not to stick to hair at low humidity, but reached an unacceptable tack level to hair under high humidity conditions.

### Example 7

We produced a plasticized PVC copolymer thread with 6.64% of vinylacetate copolymerized monomer by polymer weight %, by blending a small amount of PVC homopolymer with a major amount of 5% vinylacetate copolymer PVC and the same 14% vinylacetate copolymer used in Examples 4 and 6, but at lower level than in Example 6. This compound contained 41% by weight of plasticizers (see Compound G of Table 2); this is so, even though the ratios of liquids:polymer is essentially the same as the other compounds of Table 2, because all the fillers have been removed. This is helpful for photography which shows the cracking, as in FIGS. 2 and 3. It had tensile strength of 19 MPa and elongation to break of 383%. When this thread is stretched 150% and then exposed to either acetone (Removal Solution A) or Removal Solution D, it ruptures within 8 seconds of exposure to a small amount of acetone that is held against the vertical fiber by a saturated cotton ball. The same thread will also rupture within 6 seconds when exposed to a drop of butylene carbonate. This sample had suitably low surface tack so as not to stick to hair, even under high humidity conditions.

### Example 8

The Compound B in Table 2 is characterized by melt rheology and having η* of 1.41×10⁴ Pa-s and tan δ of 0.48 at a 150° C. and a tan S vs. η* power-law exponent of −0.503 and intercept of 1.793 for the range of 120° C. to 190° C. This compound is capable of making a thread that has break strength greater than 20 MPa and elongation greater than 300% in a conventional monofilament process.

### Example 9

We produced a plasticized PVC thread made from 67% pvc-co-5% VAc, 16.5% DINCH and 16.5% ATBC. This thread had an average break time with acetone of 18 seconds. The DMA temperature ramp from 25-43° C., plot of tan-delta versus the complex modulus E* had a slope of 1.227e-7.

### Example 10

We produced a plasticized PVC thread made from 60% pvc-co-5% VAc, 20% DINCH and 20% ATBC. This thread had an average break time with acetone of 8 seconds. The DMA temperature ramp from 25-43° C., plot of tan-delta versus the complex modulus E* had a slope of 9.412e-8.

### Example 11

We produced a plasticized PVC thread made from 43% pvc-co-5% VAc and 14% pvc-co-14% VAc, 20% DINCH and 20% ATBC, 1% coconut oil, 1% argan oil and 0.8% monoi oil. This thread had an average break time with acetone of 5 seconds. The DMA temperature ramp from 25-43° C., plot of tan-delta versus the complex modulus E* had a slope of 9.507e-8, FIG. 6.

### Example 12

We produced a plasticized PVC thread made from 29.4% pvc homopolymer and 28% pvc-co-14% VAc, 19.4% DINCH and 19.4% ATBC, 1.8% coconut oil, 1.3% argan oil and 0.6% monoi oil. This thread had an average break time with acetone of 7 seconds. The DMA temperature ramp from 25-43° C., plot of tan-delta versus the complex modulus E* had a slope of 5.26e-8, see FIG. 5.

TABLE 2

| Compound (weight %) | A | B | C | D | E | F | G |
|---|---|---|---|---|---|---|---|
| PVC and copolymers | | | | | | | |
| PVC homopolymer | 57.30% | 0.00% | 0.00% | 0.00% | 28.65% | 36.84% | 5.0% |
| PVC-co-5% Vac | 0.00% | 57.30% | 0.00% | 0.00% | 0.00% | 0.00% | 40.7% |
| PVC-co-10% Vac | 0.00% | 0.00% | 57.30% | 0.00% | 28.65% | 0.00% | 0.0% |
| PVC-co-14% Vac | 0.00% | 0.00% | 0.00% | 57.30% | 0.00% | 20.46% | 13.6% |
| Polymer % vinylacetate | 0.00% | 5.00% | 10.00% | 14.00% | 5.00% | 5.00% | 6.64% |
| Total % vinylacetate | 0.00% | 2.87% | 5.73% | 8.02% | 2.87% | 2.87% | 3.94% |
| Liquids | 35.80% | 35.80% | 35.80% | 35.80% | 35.80% | 35.80% | 40.7% |
| DINCH | 17.20% | 17.20% | 17.20% | 17.20% | 17.20% | 17.20% | 18.3% |
| A4 (ATBC) | 16.10% | 16.10% | 16.10% | 10.10% | 10.10% | 10.10% | 18.3% |
| 4 (TBC) | 0.00% | 0.00% | 0.00% | 6.00% | 6.00% | 6.00% | 0.0% |
| Coconut oil | 2.10% | 2.10% | 2.10% | 1.90% | 1.90% | 1.90% | 1.8% |
| Argon | 0.20% | 0.20% | 0.20% | 0.20% | 0.20% | 0.20% | 0.9% |
| Monoi | 0.20% | 0.20% | 0.20% | 0.20% | 0.20% | 0.20% | 0.5% |
| Mg Stearate | 0.00% | 0.00% | 0.00% | 0.20% | 0.20% | 0.20% | 0.9% |
| Filler | 6.81% | 6.81% | 6.81% | 6.81% | 6.81% | 6.81% | 0.0% |
| Mica | 0.00% | 0.00% | 0.00% | 1.00% | 1.00% | 1.00% | 0.0% |
| Cloisite (30B) | 1.10% | 1.10% | 1.10% | 1.10% | 1.10% | 1.10% | 0.0% |
| CaCO3 | 5.70% | 5.70% | 5.70% | 2.70% | 2.70% | 2.70% | 0.0% |
| Kaolin Clay | 0.00% | 0.00% | 0.00% | 1.00% | 1.00% | 1.00% | 0.0% |
| Bentonite Clay | 0.00% | 0.00% | 0.00% | 1.00% | 1.00% | 1.00% | 0.0% |
| Carbon Black (N550) | 0.01% | 0.01% | 0.01% | 0.01% | 0.01% | 0.01% | 0.0% |
| Total Mass (g) | 100% | 100% | 100% | 100% | 100% | 100% | 100% |
| Tensile Strength, MPa: | 23 | 21 | 18 | 15 | 21 | 21 | 19 |
| Elongation to break | 280% | 310% | 350% | 410% | 300% | 300% | 383% |
| tack (0-5, 5 | 0 | 0 | 4 | 5 | 0 | 3 | 2 |
| unacceptable) | | | | | | | |
| seconds to rupture, | 15 | 6 | 4 | 3 | 6 | 6 | 5 |
| acetone @ 150% strain | | | | | | | |

1. An improved thread useful for temporarily binding fibers together by being sewn or woven in with said fibers, so that the thread is under stress while binding said fibers together, wherein said thread cracks within a minute of application of a small amount of a removal solution.

2. The thread of claim 1 in which said thread is made of an elastomer.

3. The thread of claim 2 in which said thread is made of a thermoplastic elastomer.

4. The thread of claim 3 in which said thread is made of a plasticized PVC copolymer.

5. The thread of claim 4 in which said thread is made of a plasticized PVC copolymer that contains 20-50% by weight of total liquid components, stretches at least 100% in tensile testing at room temperature, and has a stress at 50% extension between 4-12 MPa, tensile strength greater than 12 MPa, and ruptures when acetone is applied to the elongated fiber within one minute.

6. The thread of claim 5 in which said thread is made of a plasticized PVC copolymer that contains 30-40% by weight of total liquid components, stretches at least 200% in tensile testing at room temperature, and has a stress at 50% extension between 5-7 MPa, tensile strength greater than 16 MPa, and ruptures when acetone is applied to the fiber within fifteen seconds.

7. The thread of claim 1 in which said removal solution is a ketone such as acetone, methylethylketone (MEK), or methylisobutylketone (MIBK) or methyl isoamyl ketone (MIAK).

8. The thread of claim 1 in which said removal solution is an ester such as butyl acetate, amyl acetate, or isoamyl acetate.

9. The thread of claim 1 in which said removal solution is a geminal diether such as methylal or ethylol.

10. The thread of claim 1 in which said removal solution is a cyclic ether such as tetrahydrofuran (THF) or dioxane.

11. The thread of claim 1 in which said removal solution is a cyclic carbonate such as propylene carbonate (PC), ethylene carbonate (EC), butylene carbonate (BC), or effective mixtures thereof that remain liquid at room temperature (20 degrees Celsius and above).

12. The thread of claim 6 in which most of the liquid content of said plasticized PVC is based on non-phthalate plasticizers such as DINCH (diisononylcyclohexane dicarboxylate), acetyltributyl citrate (ATBC), or tri-n-butyl Citrate (TBC).

13. The thread of claim 6 in which said plasticized PVC is based on non-phthalate plasticizers such as:
Bioplasticizers-example citrates (TEC: triethyl citrate)
DBS: Di-butyl sebacate
DOS: Dioctyl sebacate
TXIB: 2,2,4-trimethyl 1,3-pentanediol diisobutyrate
BHT: Butylated hydroxytoluene
DBA: Di-butyl adipate
DEHA: Di(2-ethyl hexyl) adipate
Eastman 168: bis(2-ethylhexyl)-1,4-benzenedicarboxylate
COMGHA: Acetylated monoglycerides of fully hydrogenated castor oil
TETM: Tri-2-ethylhexyl trimellitate
Mesamoll II: alkylsulphonic phenyl ester (ASE)
ESBO: Epoxidized soybean oil
DOTP: Dioctyl terephthalate

14. The thread of claim 1 in which said removal solution comprises butylene carbonate.

15. The thread of claim 6 in which said removal solution comprises butylene carbonate.

16. The thread of claim 1 in which said thread comprises a polycarbonate thread.

17. The thread of claim 1 in which said thread comprises a ABS polymer thread.

18. The thread of claim 1 in which said thread comprises a polyester thread.

19. The thread of claim 1 in which said thread comprises a polylactide or polylactide blend thread.

20. A polymeric thread prepared by the extrusion process comprising: Dry mixing PVC powder, PVC-copolymer-(co-vinylacetate), and any inorganic mineral fillers; then adding plasticizers to form a polymeric dispersion, the polymeric dispersion comprising from about 1 to 10 weight percent of PVC powder, a pvc-co-polymer (5% VAc content) from about 40 to 69 weight percent, inorganic mineral filler from about 0 to 10 weight percent and characterized by Dynamic Mechanical Spectroscopy using a frequency of 1.00 radians/sec and 25 mm parallel plates with a 1.00 mm gap to have a complex viscosity (η*) in the range of 4.0×10³ to 3.0×10⁴ Pascal-sec and loss tangent (tan δ) in the range of 0.3 to 0.9 at 150° C., and a power-law relation between tan δ and η* where the exponent is within the range between −0.65 and −0.35 for the temperature range of 120° to 190° C.

21. A polymeric thread made from PVC and PVC-co-vinylacetate comprising of 20% to 50% plasticizers and characterized by Dynamic Mechanical Spectroscopy using a frequency of 6.28 radians/sec and a Rheometric Scientific film fixture in tensile mode, using a temperature ramp in the range of 25° C. to 43° C. from a plot of tan-δ versus E* has a slope in the range of 5e-7 to 1e-8.

22. A polymeric thread made from PVC and PVC-co-vinylacetate comprising of 31% to 45% plasticizers and characterized by Dynamic Mechanical Spectroscopy using a frequency of 6.28 radians/sec and a Rheometric Scientific film fixture in tensile mode, using a temperature ramp in the range of 25° C. to 43° C. from a plot of tan-δ versus E* has a slope in the range of 3e-7 to 3e-8.

23. A polymeric thread made from PVC-co-vinylacetate (5% Vac) comprising of 32% to 38% plasticizers and characterized by Dynamic Mechanical Spectroscopy using a frequency of 6.28 radians/sec and a Rheometric Scientific film fixture in tensile mode, using a temperature ramp in the range of 25° C. to 43° C. from a plot of tan-δ versus E* has a slope in the range of 2.2e-7 to 5e-8.

24. A polymeric thread made from PVC and PVC-co-vinylacetate (5% Vac) comprising of 31% to 45% plasticizers and characterized by Dynamic Mechanical Spectroscopy at 25° C. using a frequency of 0.1 radians/sec and a Rheometric Scientific film fixture in tensile mode, had a tan-δ in the range of 0.07 to 0.3.

25. A polymeric thread made from PVC and PVC-co-vinylacetate (5% Vac) comprising of 31% to 45% plasticizers and characterized by Dynamic Mechanical Spectroscopy at 25° C. using a frequency of 0.1 radians/sec and a Rheometric Scientific film fixture in tensile mode, had a E′ (storage modulus) in the range of 1.5e6 to 7e6 pascals.

26. The thread of claim 6 contains 1.0 to 2.5 weight percent of an essential oil mixture (oils mixture contains Coconut, Argan, and Monoi).

27. The thread of claim 3 in which said thread is made of a triblock thermoplastic elastomer such as Kraton polymers.

28. The thread of claim 3 in which said thread is made of a multiblock thermoplastic elastomer such as thermoplastic polyurethanes or Hytrel block copolyesters.

29. The thread of claim 3 in which said thread is made of a dynamic vucanizate thermoplastic elastomer such as the Santoprene dynamically vulcanized polymer blends.

30. The thread of claim 2 in which said thread is comprised of crosslinked natural rubber thread.
